(19) United States
(12) Patent Application Publication
(10) Pub. No.: US 2016/0321332 A1
(43) Pub. Date: Nov. 3, 2016

(54) DATABASE SCALING WITH ISOLATION

(71) Applicant: Microsoft Technology Licensing, LLC, Redmond, WA (US)

(72) Inventors: Yang Xiang, Issaquah, WA (US); Nobuya Higashiyama, Snohomish, WA (US); Krishna Raghava Mulubagilu Panduranga Rao, Redmond, WA (US); Sathia Thirumal, Bothell, WA (US); David C. Oliver, Bellevue, WA (US); Mingquan Xue, Redmond, WA (US); Parul Manek, Redmond, WA (US); Surinderjeet Singh, Renton, WA (US)

(21) Appl. No.: 14/861,818

(22) Filed: Sep. 22, 2015

Related U.S. Application Data
(60) Provisional application No. 62/156,121, filed on May 1, 2015.

(51) Int. Cl. G06F 17/30

(52) U.S. Cl. CPC G06F 17/30569; G06F 17/30371; G06F 17/30876

(57) ABSTRACT

A data storage system includes a source database and a target database. A data isolation component is configured to identify content in the source database that will be moved to the target database. A data move component is configured to move the content identified in the source database to the target database. Upon completion of moving the content from the source database to the target database, the move component is configured to update a mapping database in a single operation such that data access request for the moved content are directed to the target database.

### CROSS-REFERENCE TO RELATED APPLICATION

The present application is based on and claims the benefit of U.S. provisional patent application Ser. No. 62/156,121, filed May 1, 2015, the content of which is hereby incorporated by reference in its entirety.

### BACKGROUND

Database systems are currently in wide use. In general, a database system includes a server that interacts with a data storage component to store data (and provide access to it) in a controlled and ordered way. In one example, a database system includes one or more data centers, each having one or more servers.

The discussion above is merely provided for general background information and is not intended to be used as an aid in determining the scope of the claimed subject matter.

### SUMMARY

A data storage system includes a source database and a target database. A data isolation component is configured to identify content in the source database that will be moved to the target database. A data move component is configured to move the content identified in the source database to the target database. Upon completion of moving the content from the source database to the target database, the move component is configured to update a mapping database in a single operation such that data access request for the moved content are directed to the target database.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a data storage provider in accordance with one embodiment.

FIG. 2 is a flow diagram of a method of scaling data storage in order to maintain acceptable service metrics in accordance with one embodiment.

FIG. 3 is a block diagram of a computing system architecture.

FIGS. 4A and 4B show a flow diagram illustrating one example of the operation of the architecture shown in FIG. 3 in moving data from a source container to a target container.

FIG. 5 is a flow diagram showing one example of the operation of the architecture shown in FIG. 3 in isolating data and redirecting users.

FIG. 6 shows an example of a cloud computing architecture.

FIG. 7 is a block diagram of a computing environment that can be used in any of the architectures shown in the previous figures.

### DETAILED DESCRIPTION

In some large database systems, such as cloud-based data storage systems, the limits of database technology can affect system performance. For example, an online content storage system that is provided to a number of customers may use a database technology such as SQL as the storage provider. As the database size scales up (with increased users and/or content) the service performance can be impacted due to inherent limitations in the database technology. In accordance with embodiments described herein, as databases scale up, they may reach a threshold or have one or more performance metrics that indicate that it is useful to isolate and migrate content into a new database. In this way, virtually infinite scale can be provided by continually adding databases. Embodiments described herein may generally monitor database service metrics and smoothly and transparently manage scale without impacting a user's experience.

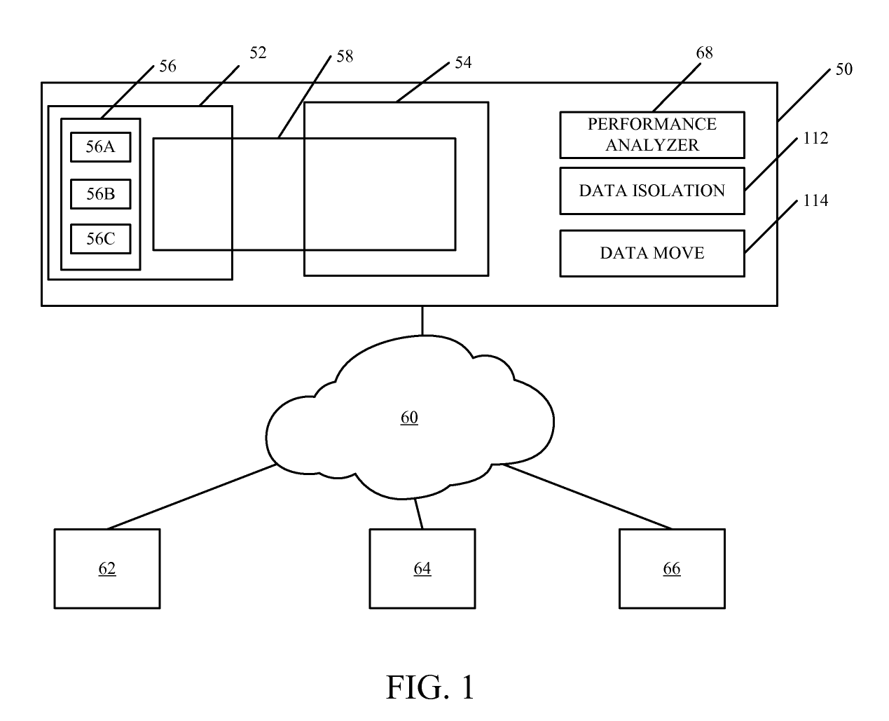

FIG. 1 is a diagrammatic view of a data storage provider in accordance with one embodiment. Data storage system 50 is illustratively shown with a pair of servers 52 and 54. While only a pair of servers are shown for simplicity, data storage system 50 may, in fact, include tens or hundreds of servers. In the example shown in FIG. 1, data storage provider is a multi-tenant data storage provider because data storage system stores first tenant data 56 and second tenant data 58. First tenant data 56 may include first tenant sites/content 56-a, 56-b, and 56-c. Again, only a couple of tenants are shown, when in fact there may be thousands of such tenants. Additionally, as shown, tenant data 56 may only require a fraction of the resources provided by server 52, while tenant data 58 may require the resources of a plurality of such servers, this is shown by tenant data 58 spanning servers 52 and 54.

Data storage system 50 is coupled to network 60, which may be a local area network, a wide area network, such as the internet, or a combination thereof. Through network 60, clients 62, 64, 66 may access data in data storage system 50. Client 62 may belong to the owner of tenant data 56 and thus will access tenant data 56. Similarly, clients 64 and 66 may belong to the owner of tenant data 58 and will access tenant data 58. As can be appreciated, since physical resources may be shared among multiple tenants in data storage system 50 it is possible that as one tenant's data grows, the performance of data system 50 in responding to other tenants' data requests may be affected.

In accordance with one embodiment, data storage system 50 includes performance analyzer 68, data isolation component 112, and data move component 114. Performance analyzer may be a component of data storage system 50 or it may be separated from data storage system 50 and able to access data storage system 50 via network 60. Performance analyzer 50 is configured to access performance statistics and metrics relative to hardware and/or software components of data storage system 50. As set forth above, databases that employ SQL technology may suffer adverse performance when the data stored therein grows very large. Examples, of performance statistics and metrics includes, without limitation, overall size of data storage, size of data storage relative to hardware capacity, time required to perform one or more standard database operations (either stored historically, or as tested by performance analyzer 68), log information relative to one or more servers, or any other suitable information that may be indicative of performance changes relative to data storage system 50. Additionally, performance analyzer 68 may run one or more performance tests on hardware or software components of data storage system 50 in order to determine any of the performance statistics or metrics listed above.

Performance analyzer 68 may, in one embodiment, consult pre-defined performance thresholds relative to any of the metric and/or statistics listed above to determine when to move some or all data from one server or data storage system to another in order to maintain an acceptable performance level. The pre-defined performance thresholds may be different for different tenants of the data storage system, such as when they are defined by the tenants. Additionally, the pre-defined performance thresholds may be related to a particular service tier. Thus, a tenant may select a first tier for information that is not mission critical to the tenant, and may select a second, higher tier service for tenant information that is mission critical to the tenant. Thus, the same system performance may cause the mission critical information to be moved to another server before the first tier information.

Once performance analyzer 68 determines that a data move is warranted, data isolation component 112 identifies content within the source system that will be moved to a new target system. In one embodiment, isolation component 112 attempts to group or otherwise identify content to move such that the load will be balanced equally among the source and target systems once the move is complete. Thus, in one embodiment, half of the contents on the source system are grouped or otherwise identified for moving. However, isolation component 112 can also select content and/or sites such that perhaps one large site moves. Additionally, isolation component 112 can select data from one or more tenants to move into the target system. Finally, isolation component 112 can select data from higher level tiers to move to the target system.

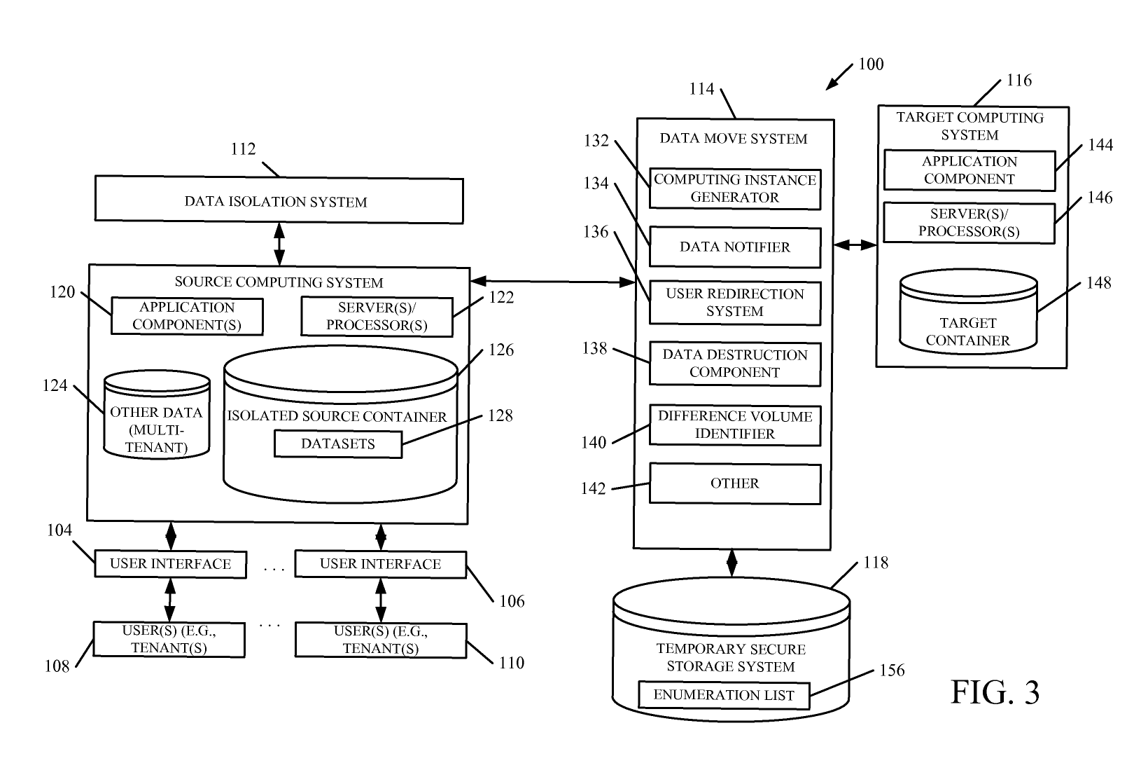

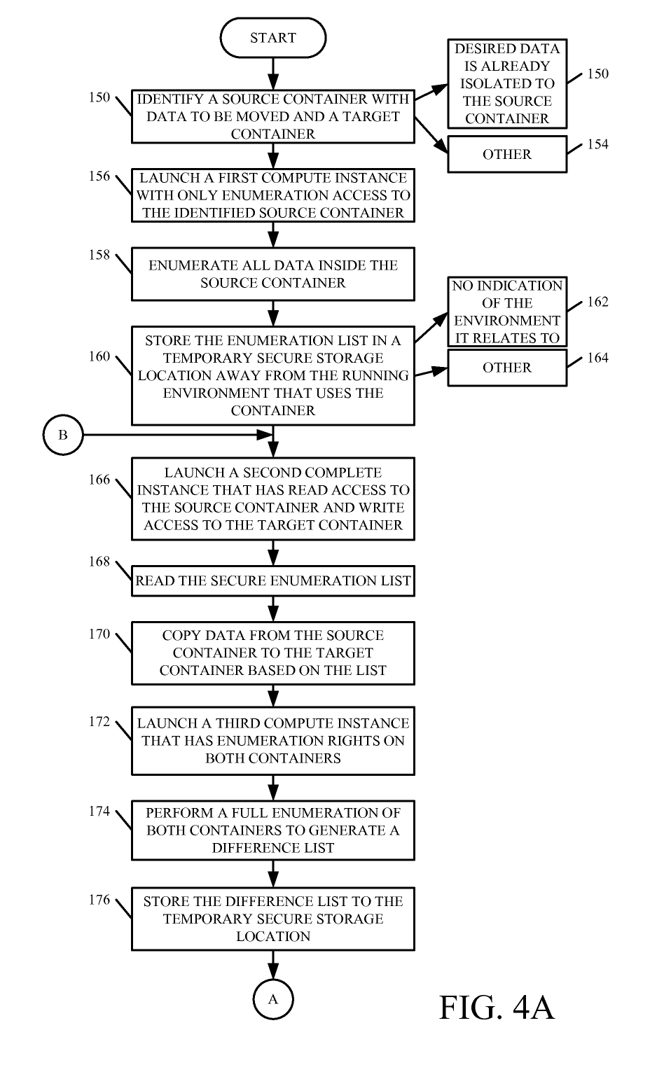

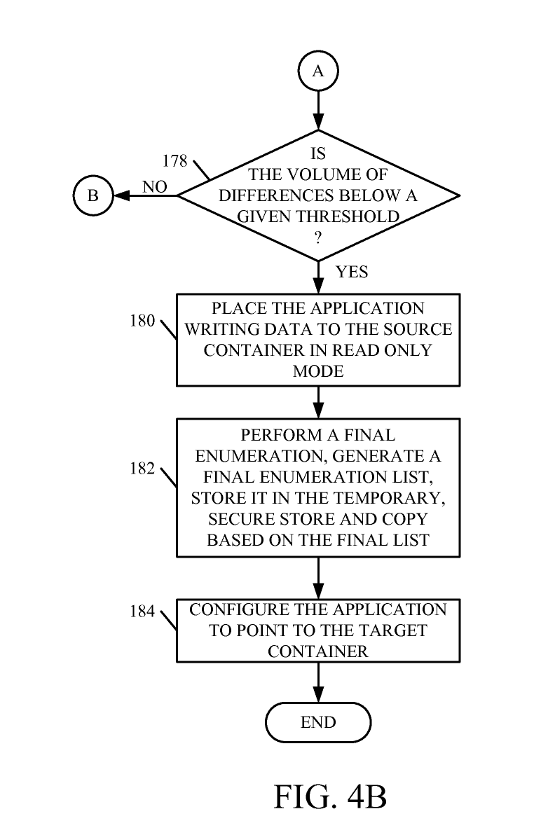

Once isolation component 112 has identified content to move from the source system to the target system, data move component 114 performs the data move process without generating and user-perceivable performance impact. In embodiments that employ SQL technology, the data move process can employ log shipping to clone the database without generating impacting the availability of the data in the primary or source database. A generic description of the move process will be described in greater detail below with respect to FIGS. 3, 4A, and 4B.

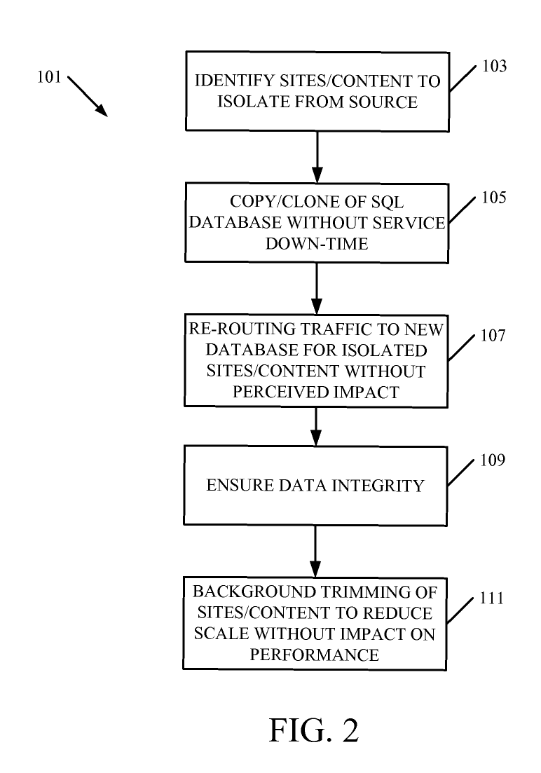

FIG. 2 is a flow diagram of a method of scaling data storage in order to maintain acceptable service metrics in accordance with one embodiment. Method 101 may be executed at any suitable time. For example, method 101 may be initiated manually by an operator of the database system in order to improve service metrics or prepare the database system for a significant influx of new sites/content. Additionally or alternatively, method 101 may be initiated automatically when one or more relevant service metrics of the database system (such as latency, capacity, et cetera) reach a predefined threshold.

Method 101 begins with block 103 where one or more sites or content is identified and isolated from the source database. The manner in which this can occur can take any suitable form. For example, an operator may specify sites/content to be isolated. Alternatively, the various sites/content stored in the database system can be analyzed to determine a grouping that will result, nominally, in about half of the sites/content being isolated. By targeting half of the sites/content to be isolated and cloned to the target database, the size of the two databases (source and target) will be minimized. However, embodiments can be practiced where non-even splits are used. Further, isolation component 112 may simply identify a single, large block of data or tenant site, and isolates that tenant's data for moving to the target database. Accordingly, embodiments described herein may be considered to divide the database on a user-specified axis. Thus, the content isolated for moving to the target database could be content from one or more tenants, sites or content from a single tenant, or sets of sites from one or more tenants. The user-specification can be provided in any suitable manner including via a user interface of a control or administration application, via an application programming interface, or any other suitable manner.

Once the sites/content is isolated at block 103, control passes to block 105 where a continuous copy/clone process of the database is initiated for the isolated sites/content. As set forth above, in one embodiment, block 103 uses log shipping to generate a clone of data without affecting the availability of the data in the source database. Thus, a replica of the source database data is created without any tenant-perceived impact (such as downtime) on availability of the source data.

At block 107, traffic to the database system is re-routed to the new database for isolated sites/content that have been copied/cloned to the new database. In one embodiment, this re-routing occurs substantially immediately in a single operation. The single operation may be an update to a mapping database that changes the host for all the sites/content that are being moved such that data access requests for the moved sites/content are sent to the new database. In one example, the mapping database may be a domain name system.

At block 109, consistency validation is performed in order to ensure the integrity of the isolated sites/content. Before the split is performed, an inventory of all the sites that are on the database is taken. Then, after the split, another inventory of all the sites on the source and target is taken. In one embodiment, consistency validation includes a comparison of the two inventories (before-split and after-split) to ensure that no sites/content was lost in the process.

Finally, at block 111, sites/content in the SQL databases is trimmed in order to reduce database scale without impacting database performance. In one embodiment, this trimming process is performed as a gradual, background, batched deletion. This helps ensure that the process does not cause blocking or otherwise affect operations on the source database. Further, since the operation occurs in the background and without blocking, the amount of time required for the process to complete (several hours to a few days) does not cause any issues.

While embodiments described herein are particularly useful for cloud-based database and storage implementations, embodiments can be practiced for any database system that may have performance limitations as the database scales up. Embodiments described herein are useful any time it is desirable to identify when and what to data/sites to move from a source database to a target database. Thus, embodiments described herein are applicable to data moves within a single computing device; moves from a single computing device to another computing device; moves from a single computing device to multiple computing devices in the same data storage provider; moves from multiple computing devices to multiple additional computing devices in the same installation; moves from a single computing devices to a cloud-based installation; moves from multiple computing devices in the same data storage provider to a cloud-based installation; moves between multiple cloud based installations of the same data service provider; and moves between multiple, distinct cloud-based data storage providers. Further, while any suitable techniques can be used for cloning/copying the isolated data from the source database to the new (target) database, one system and method for such cloning/copying is set forth below with respect to FIGS. 3, 4A and 4B.

FIG. 3 is a block diagram of various components of one illustrative data storage architecture 100. Data storage architecture 100 illustratively includes a source computing system 102 that generates user interface displays 104-106 with user input mechanisms for interaction by users 108-110. Users 108-110 interact with the user input mechanisms to control and manipulate source computing system 102.

Architecture 100 can also include data isolation system 112, data move system 114 and target computing system 116, along with temporary secure storage system 118. Source computing system 102 illustratively includes application component 120, servers or processors 122, multi-tenant data in data store 124 and data to be moved in source container 126. The data to be moved can be broken into datasets 128. Data move system 114 illustratively includes computing instance generator 132, data notifier 134, user redirection system 136, data destruction system 138, difference volume identifier 140, and it can include other items 142 as well. Target computing system 116 illustratively includes application component 144, servers or processors 146 and target container 148.

By way of overview, application components 120 and 144 illustratively run applications or services on systems 102 and 116, respectively. When tenant data (or any portion of data) is to be transferred from source system 102 to target system 116, data isolation system isolates that data into source container 126. It can also identify datasets 128 based on their metadata, their frequency of use, or based on a wide variety of other criteria. Data move system 114 begins to move the data from source container 126 to target container 148. When the datasets 128 have been successfully moved, data notifier 134 notifies redirection component 136, which redirects users 108-110 (the users of the data being moved) to be serviced by target computing system 116 and target container 148 in a single operation as set forth above with respect to block 107 (shown in FIG. 2). After redirection, the source data sets are destroyed in a gradual, background batch operation on source computing system, 102.

FIGS. 4A and 4B (collectively referred to as FIG. 4) show a flow diagram illustrating the operation of architecture 100 in moving data, and ensuring that all isolated data has been moved from the source container to the target container. Data move system 114 first identifies the source and target containers 126 and 148. This is indicated by block 150. It is assumed that data isolation system 112 has already identified the data to be moved and isolated it into its own data container (or its own set of data containers) 126, which has no other tenant data (or other data that is not to be moved to system 116) in it. This is indicated by block 152. This can be done in other ways as well, as indicated by block 154.

Computing instance generator 132 then launches a first computing system instance that only has enumeration rights to source container 126. The first instance then enumerates all data inside container 126 into an enumeration list 156. Launching the first computing instance and enumerating the contents of source container 126 is indicated by blocks 156 and 158, respectively.

The list is stored in temporary secure storage system 118. System 118 is illustratively in a physically separate location from source computing system 102, as indicated by block 160. The enumeration list illustratively has no indication that it relates to the environment of source computing system 102. It can be made in other ways as well. This is indicated by blocks 162 and 164.

Once the enumeration list is stored in storage system 118, computing instance generator 132 launches a second computing system instance that has read access to source container 126 and write access to target container 148. This is indicated by block 166. It reads the secure enumeration list 156 and copies data from the source container to the target container. It reads the secure enumeration list 156 and copies data from the source container 126 to the target container 148 based on the enumeration list. This is indicated by blocks 168 and 170.

Computing instance generator 132 then generates a third computing instance that has enumeration access to both source container 126 and target container 148. It performs a full enumeration of both containers and compares them to generate a difference list, which now becomes the new enumeration list of items to be moved. Launching the third computing instance, performing the full enumeration and storing the difference list in the secure store is indicated by blocks 172, 174 and 176, respectively.

Difference volume identifier 140 then determines whether the volume of the differences (e.g., the number or size of items in the difference enumeration list) meets a given threshold. This is indicated by block 178. If not, processing reverts to block 166 where the migration continues without interrupting the operation of source container 126, with respect to its users 108-110.

The threshold is illustratively set low enough that the subsequent migration of the remaining data will last for a sufficiently short time that the source container 126 can be placed in read only mode, without a significant, negative impact on users 108-110 of the source container. Placing it in read only mode is indicated by block 180.

A computing instance performs a final enumeration of the source and target containers 126 and 148 to identify a final enumeration list, and a final copy of data is performed from source container 126 to target container 148. This is indicated by block 182. The application is then configured to point the users 108-110 of the data that was moved to target container 148, and subsequent user requests are serviced by target computing system 116 and target container 148. This is indicated by block 184.

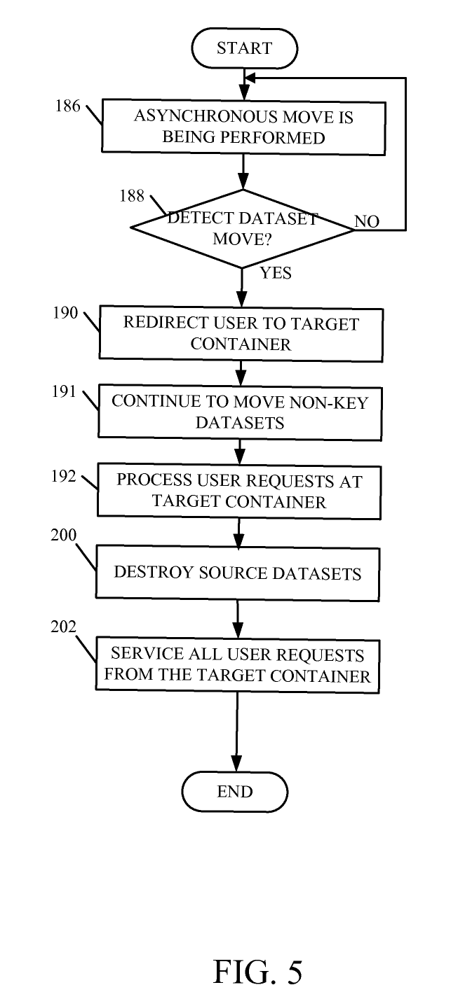

FIG. 5 is a flow diagram illustrating another example of the operation of data move system 114 in moving data and redirecting users. It is first assumed in FIG. 5 that an asynchronous move is being performed as discussed above. This is indicated by block 186. In one example, the computing instances enumerate the datasets 128 and identify them as such. As soon as all datasets 128 are moved, data notifier 134 notifies the user redirection system, and user redirection system redirects the users 108-110 of the data in source container 126 to target computing system 116 and target container 148. This is indicated by blocks 188 and 190 in FIG. 5. Target system 116 then processes user requests from target container 148. This is indicated by block 192.

When all datasets are copied to target container 148, data destruction component destroys the source datasets in source container 126. This is indicated by block 200.

After that point, all user requests are serviced from target computing system 116 and target container 148. This is indicated by block 202.

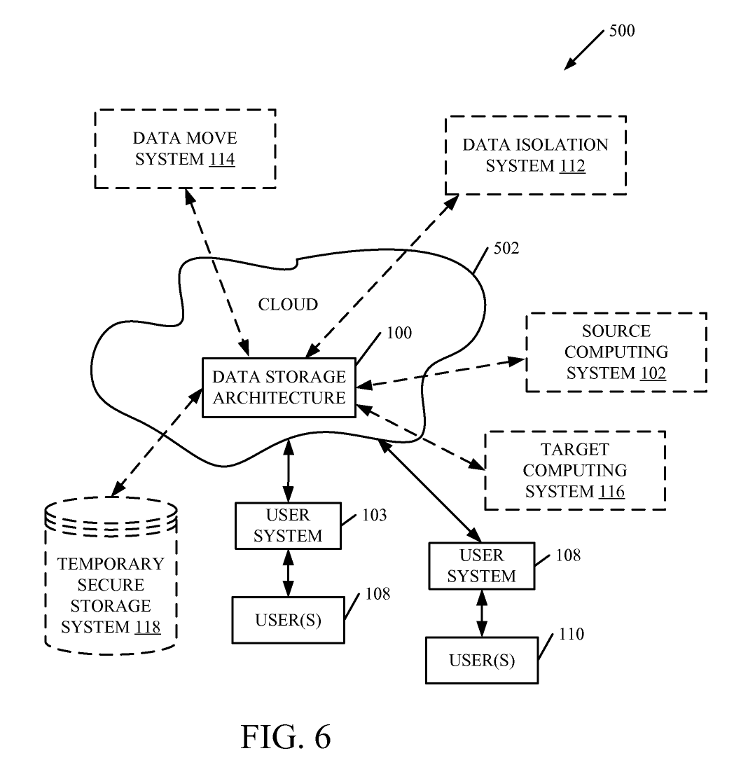

FIG. 6 is a block diagram of a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of computing architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 6, some items are similar to those shown in FIG. 3 and they are similarly numbered. FIG. 6 specifically shows that some or all components of architecture 100 are located in cloud 502 (which can be public, private, or a combination where portions are public while others are private). Therefore, user 504 (e.g., users 108 and/or 110) uses a user device 506 to access those components through cloud 502.

FIG. 6 also depicts another embodiment of a cloud architecture. FIG. 6 shows that it is also contemplated that some elements of architecture 100 are disposed in cloud 502 while others are not. For example, system 102 can be disposed outside of cloud 502, and accessed through cloud 502. In another example, system 116 can be disposed outside of cloud 502, and accessed through cloud 502. In another example, system 114 can be disposed outside of cloud 502, and accessed through cloud 502. In another example, system 118 can be disposed outside of cloud 502, and accessed through cloud 502. Regardless of where they are located, they can be accessed through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

The present discussion mentions a variety of different components. It will be noted that the components can be consolidated so that more functionality is performed by each components, or they can be divided so that the functionality is further distributed.

It should also be noted that the above discussion has shown one or more data stores. Each data store can be any of a wide variety of different types of data stores. Further, the data in the data store can be stored in multiple additional data stores as well. Also, the data stores can be local to the environments, agents, modules, and/or components that access them, or they can be remote therefrom and accessible by those environments, agents, modules, and/or components. Similarly, some can be local while others are remote.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

Also, the figures show a number of blocks with functionality ascribed to each block. It will be noted that fewer blocks can be used so the functionality is performed by fewer components. Also, more blocks can be used with the functionality distributed among more components.

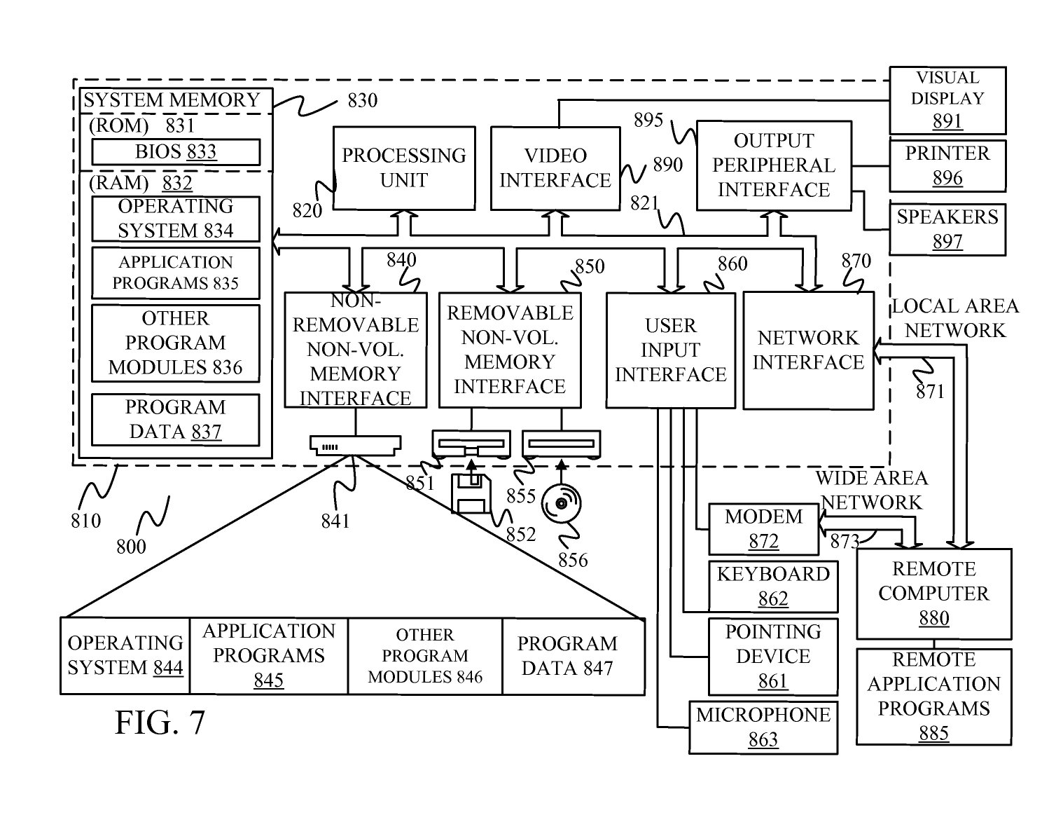

FIG. 7 is a block diagram of a computing environment that can be used in any of the architectures shown in the previous figures. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 7, provide storage of computer readable instructions, data structures, program modules and other data for the computer 810. In FIG. 7, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 7 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 7 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a data storage system that includes a source database and a target database. A data isolation component is configured to identify content in the source database that will be moved to the target database. A data move component is configured to move the content identified in the source database to the target database. Upon completion of moving the content from the source database to the target database, the move component is configured to update a mapping database in a single operation such that data access request for the moved content are directed to the target database.

Example 2 is the data storage system of any or all previous examples wherein the data isolation component is configured to identify content on the source database in order to balance load among the source database and the target database.

Example 3 is the data storage system of any or all previous examples wherein the data isolation component is configured to identify half of the content in the source database to move to the target database.

Example 4 is the data storage system of any or all previous examples wherein the source database includes data of multiple tenants, and wherein the data isolation component is configured to identify content from a single tenant to move to the target database.

Example 5 is the data storage system of any or all previous examples wherein the data move component is configured to move the identified content from the source database to the target database without affecting availability of the identified content in the source database.

Example 6 is the data storage system of any or all previous examples wherein the data move component employs a log shipping process to move the identified content from the source database to the target database.

Example 7 is the data storage system of any or all previous examples wherein the mapping database is a domain name system.

Example 8 is the data storage system of any or all previous examples and further comprising a performance analyzer configured to analyze at least one performance parameter of the source database in order to automatically trigger the data isolation component to begin identifying content in the source database that will move to the target database.

Example 9 is the data storage system of any or all previous examples wherein the at least one performance parameter includes a size of data storage relative to hardware capacity.

Example 10 is the data storage system of any or all previous examples wherein the source database is a SQL database.

Example 11 is the data storage system of any or all previous examples wherein the data storage system is embodied on a single device.

Example 12 is the data storage system of any or all previous examples wherein upon completion of moving the content from the source database to the target database, the data move component is configured to trim content from the source database.

Example 13 is the data storage system of any or all previous examples wherein the data move component is configured to trim content from the source database using a background deletion operation.

Example 14 is the data storage system of any or all previous examples wherein the background deletion operation is a batch operation.

Example 15 is a computer-implemented method of moving content from a source database to a target database. The method includes identifying a content in a source database for moving to a target database and copying the identified content from the source database to the target database. Upon completion of copying the identified content, a mapping database is updated so data access requests for the moved content are sent to the target database. Source content is trimmed using a background task after the mapping database has been updated.

Example 16 is the computer-implemented method of any or all previous examples wherein the source database and the target database are on the same computing device.

Example 17 is the computer-implemented method of any or all previous examples wherein the source database and the target database are on different computing devices.

Example 18 is the computer-implemented method of any or all previous examples wherein the different computing devices are of the same data storage provider.

Example 19 is the computer-implemented method of any or all previous examples wherein the different computing devices and the target database is a cloud-implemented database.

Example 20 is a cloud-based data storage system including a source SQL database and a performance analyzer configured to monitor the source SQL database and determine when to move content to a target database. A data isolation component is configured to identify content in the source SQL database that will be moved to the target database when the performance analyzer determines a time to move content to the target database. A data move component is configured to move the content identified in the source SQL database to the target database using log shipping.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A data storage system comprising:
a source database and a target database;
a data isolation component configured to identify content in the source database that will be moved to the target database;
a data move component configured to move the content identified in the source database to the target database; and
wherein upon completion of moving the content from the source database to the target database, the move component is configured to update a mapping database in a single operation such that data access request for the moved content are directed to the target database.

2. The data storage system of claim 1, wherein the data isolation component is configured to identify content on the source database in order to balance load among the source database and the target database.

3. The data storage system of claim 2, wherein the data isolation component is configured to identify half of the content in the source database to move to the target database.

4. The data storage system of claim 1, wherein the source database includes data of multiple tenants, and wherein the data isolation component is configured to identify content from a single tenant to move to the target database.

5. The data storage system of claim 1, wherein the data move component is configured to move the identified content from the source database to the target database without affecting availability of the identified content in the source database.

6. The data storage system of claim 5, wherein the data move component employs a log shipping process to move the identified content from the source database to the target database.

7. The data storage system of claim 1, wherein the mapping database is a domain name system.

8. The data storage system of claim 1, and further comprising a performance analyzer configured to analyze at least one performance parameter of the source database in order to automatically trigger the data isolation component to begin identifying content in the source database that will move to the target database.

9. The data storage system of claim 1, wherein the at least one performance parameter includes a size of data storage relative to hardware capacity.

10. The data storage system of claim 1, wherein the source database is a SQL database.

11. The data storage system of claim 1, wherein the data storage system is embodied on a single device.

12. The data storage system of claim 1, wherein upon completion of moving the content from the source database to the target database, the data move component is configured to trim content from the source database.

13. The data storage system of claim 12, wherein the data move component is configured to trim content from the source database using a background deletion operation.

14. The data storage system of claim 13, wherein the background deletion operation is a batch operation.

15. A computer-implemented method of moving content from a source database to a target database, the method comprising:
identifying a content in a source database for moving to a target database;
copying the identified content from the source database to the target database;
upon completion of copying the identified content, updating a mapping database so data access requests for the moved content are sent to the target database; and
trimming source content after the mapping database has been updated, wherein trimming is performed as a background task relative to the source database.

16. The method of claim 1, wherein the source database and the target database are on the same computing device.

17. The method of claim 1, wherein the source database and the target database are on different computing devices.

18. The method of claim 17, wherein the different computing devices are of the same data storage provider.

19. The method of claim 17, wherein the different computing devices and the target database is a cloud-implemented database.

20. A cloud-based data storage system comprising:
a source SQL database;
a performance analyzer configured to monitor the source SQL database and determine when to move content to a target database
a data isolation component configured to identify content in the source SQL database that will be moved to the target database when the performance analyzer determines a time to move content to the target database;
a data move component configured to move the content identified in the source SQL database to the target database using log shipping.
